(19) United States
(12) Patent Application Publication
(10) Pub. No.: US 2003/0039788 A1
(43) Pub. Date: Feb. 27, 2003

(54) Cutting mat for material sampling

(76) Inventor: Joel Steven Harris, Gloucester (CA)

Correspondence Address: Joel S. Harris, 6073 Valley Field Cres., Gloucester, ON, K1C 5P3, CA

(21) Appl. No.: 10/218,467

(22) Filed: Aug. 15, 2002

(30) Foreign Application Priority Data
Aug. 17, 2001 (CA) 2,356,559

(51) Int. Cl. B32B 9/00

(52) U.S. Cl. 428/40.1

(57) ABSTRACT

A recordable cutting mat supporting materials sampled for scientific analysis. Manufactured from extruded flat transparent polymer sheet of variable size and thickness. Source material placed on the cutting mat. Using a sharp cutting device, downward pressure is applied to the material through the cutting device until contact is made between the cutting device and the source material. Downward pressure continues until the cutting device penetrates the source material, making contact with the cutting mat surface. The mat surface is scored, not perforated, with a cut line from the cutting device which leaves a permanent visual record of the shape and location of the cut line produced. This record identifies prior cuts on the mat to avoid when the mat is reused, reducing the potential for cross contamination. The mat may be rinsed with ethanol for reuse or is disposable. The mats are transparent for use with transmitted light.

### BACKGROUND OF THE INVENTION

1. Field of Invention

This invention relates to the extraction of samples from larger source materials. Source materials may include food products, textiles, polymers, stationary products, art supplies, human or animal tissues or other substrates. A cutting support is necessary upon which to place the source material to be sampled. The cutting support offers several functions including protection for a working surface that might otherwise be damaged during the sample extraction process. A pliable cutting support may offer advantages during sampling with certain devices such as coring tools, where the sample may be pushed into the coring tool when the cutting tip penetrates the pliable surface. Inert materials used for cutting supports may be easily cleaned and are not reactive with source materials or contribute contamination. In certain applications the source material may contaminate the cutting surface by leaving artefacts resulting from prior sample extraction. The surface must then be cleaned prior to each subsequent sample extraction, if the cutting mat is re-used. Cleaning between sample extractions may decrease throughput and become a rate determining step in any sampling program. Pliable sample supports offer the unique feature of self-healing or annealing once the cutting device is removed from the cut area in the mat. This conceals marks on the support and increases the active surface used for cutting. However, when used for biological or related applications where cross contamination may be a factor, the annealed areas may become sites for stored artefacts and contaminants which may not be easily sterilized when cleaning between sample extractions. This new invention offers the unique feature of capturing all sample extractions where a cutting device is used. This allows the user to quickly avoid these areas and reduce potential cross contamination.

2. Description of Prior Art Numerous materials have been used in the past as supports upon which to extract a sample from a larger source material. These cutting supports include wood cutting blocks for the preparation of food, thick plastic food preparation boards again for food preparation, self-healing polyvinyl mats for use in the garment and textile industries as well as in art for preparing background mats for picture framing. More recently the pliable, self-annealing, polyvinyl mats have been used in biotechnology and chemical research for the preparation of a variety of sample materials including human and animal tissue, bloodstain filter cards, polymers and other materials to undergo subsequent chemical analysis. Typical cutting mats and related prior art are shown, for example, in the following United States of America Patents:

| D0435,064 | Nicholson |
|---|---|
| D0416,768 | Lisser et al. |
| 6,218,469 | Morizono et al. |
| 6,164,478 | Cant |
| 5,472,790 | Thompson |
| 5,386,654 | Kroenke |
| 5,059,271 | Taub |
| 5,052,118 | Beitler |
| 4,192,494 | Rikichi |
| 3,624,238 | McKenzie |
| 1,777,309 | Hopkinson |

These examples of cutting mat applications have known deficiencies which limit their usefulness for preparing samples from materials for scientific analysis. The surfaces of wood and plastic have sufficient porosity to harbor contaminants; are meant for repeated use and are therefore more expensive and not considered disposable, a desired characteristic for scientific sample preparation to avoid cross contamination from repeated use. These prior art inventions are heavy and are therefore used in one location and are not easily transported. In one arrangement a food product is placed on a plastic mat and cut by applying downward pressure with a sharp cutting device. Some lateral reciprocal action may be required by the operator using the cutting device to cut the food and make contact with the top surface of the cutting mat. This results in a cut line or groove in the surface.

In another prior art application an optionally laminated polyvinyl or other rubber composition cutting mat is used in the art and sewing industries, respectively, for cutting cardboard mat for picture framing or preparing cloth for quilting and the like. As the materials being cut and the rubber surface on which they are prepared are relatively inert, there is little or no cross contamination to affect subsequently cut materials on the same surface or the same cutting device used repeatedly on different cloth for instance. As there is no concern for cross contamination this allows repeated cutting of different materials on the same cutting mat. The most unique feature of this prior art mat is its “self-healing” characteristic which allows scored cut lines in the surface to be closed once the cutting device (typically a blade) is removed from the mat. The mats are usually laminated and composed of two soft outer surfaces sandwiching a harder, central layer which limits penetration to the underside (opposing cutting surface). The mats are manufactured in different sizes and thicknesses making them relatively portable and useful as a cutting support for a variety of dimensioned materials. These mats are inexpensive because of there intended reuse and self-healing surface which increase the life of the cutting surface making them an attractive cutting support for a variety of applications. However, and unfortunately, one application of these mats and those mentioned previously, is not for the preparation of samples from source materials selected for sensitive scientific analysis such as DNA profiling where cross contamination is a continuing concern. Such materials found in the scientific community may range from living or dead human and animal tissue for DNA analysis, agricultural samples, intermediate products developed during a scientific experiment or any materials which are to be subjected to sensitive scientific analysis for the purposes of identifying components. Cross contamination is a continuing concern during preparative steps leading to the scientific analysis stage. Therefore scientists routinely rely on tools which are inexpensive and suitably disposable after one use. One need look no further than the medical profession which is built on disposable tools for patient examination.

Use of any of the above described prior art cutting mat inventions for extracting samples from source materials for sensitive scientific analysis presents a number of problems which may contaminate the scientific analysis of the extracted sample. Those cutting mats described in the prior art were not designed as a support for cutting samples from materials such as human and animal tissue, plant material, food products, etc., for subsequent scientific analysis. These mats are susceptible to cross contamination and cannot be thoroughly cleaned to avoid cross contamination from being identified as interfering artefacts through sensitive scientific testing. Bacteria formed from artefacts of sample material remaining in the annealed areas on these cutting mats or previous sampled material adhering or fixed in a sample cut line (groove) may remain in the mat. While the plastic or wood cutting boards or mats may show some, or all, of any cuts produced on the surface when preparing samples of materials for scientific analysis, these cut lines cannot always be seen in every case and therefore cannot be avoided upon repeated sampling, nor are they intended to be avoided as these prior art mats are specifically designed for re-use in their particular application. It would be necessary to avoid such prior cuts on such mats if intended for repeated use with different materials sampled for scientific analysis. These mats are not suited for sampling materials for sensitive scientific analysis but rather the preparation of large food products for subsequent consumption or materials that themselves do not offer biological contaminations such as textiles or mat board used in picture framing.

The polyvinyl restorative nature of the second example of prior art inventions conceals the knife line when the knife is removed from the mat surface. This makes it impossible to see previous cuts in the mat surface and therefore to avoid these cuts when conducting subsequent sampling of different materials on the same mat. This may result in potential cross contamination of the cutting device and other source materials, and samples prepared from these other materials. The cost, size and weight of the wood and plastic materials listed in the prior art make them unsuitable for a disposable cutting surface. Although the polyvinyl mats are relatively inexpensive they too are too expensive to be used in a disposable manner. All three prior art materials are sufficiently rigid that they cannot be flexed into a shallow funnel to direct cut samples or remaining materials into collecting containers or onto other surfaces. These mats are not transparent and cannot be used in conjunction with transmitted light or placed on top of reference information which may need to be referred to during the sampling of a material.

### SUMMARY OF INVENTION

In a preferred embodiment of this invention, the deficiencies of the prior art devices are resolved by a manufactured extruded sheet of clear, anti-static, fully amorphous co-polymer (such as polyester resin glycol component (PET—Polyethylene terephthalate), poly styrene or other), a thermoplastic, cut to any desired size to support source materials which may be portioned with a sharp cutting device into smaller samples for the purpose of scientific analysis. Unlike the prior art, our invention generates a clear, visual record of the penetration of the cutting device in the mat surface. This is of value for repeat sampling of dried materials as there may be an interest to reuse the cutting mat to sample different dried materials or the same dried material (i.e. repeated sampling of dried blood on a blood filter cards or on clothing at a crime scene). This visual record enables the user to conduct subsequent sampling without penetrating a prior cut line on the mat. For viscous or semi liquid materials such as human or animal tissue, the inexpensive cost of each cutting mat increases the likelihood of preferred disposal after each use thereby avoiding potential cross contamination which is possible with these viscous materials. The nature of the materials sampled are susceptible to leaving minute artefacts which can become lodged or embedded in the cut line penetrating the surface of the cutting mat. This is also true in the prior art, however, in the example of the polyvinyl/rubber cutting mat, the restorative characteristic which is activated upon removal of the cutting device from the cut line, conceals previous cut lines produced during prior sampling of source materials and therefore also conceals the artefacts left behind during this prior sampling.

A further advantage of our invention in addition to the inexpensive unit cost is the ability to produce our mats in dimensions to not only suit any preferred material size but dimensions which can be designed for registration with pre-designed substrates such as sheets of paper, blood cards of different dimensions, etc. For instance our invention may be cut to the same dimensions as an FTA™ blood filter card. The plastic cutting mat may be positioned within the blood filter card, thus becoming associated with this particular blood filter card. All samples cut from this blood filter card would be prepared on the same cutting mat without concern for overlapping cut lines. This registration of the mat with the card allows the mat to become a permanent record of the size and number of samples collected from a particular corresponding blood filter card in the event the card is lost, destroyed or sampled without prior authorization. Similar pre-cut cutting mats may be prepared for registration with other standard size collecting substrates such as sheets of paper bearing ink, copier toner sheets, correction fluid on paper, credit card materials or currency notes which may require ink, paper or security fibre analysis when suspected of being counterfeit. Manufacturers of ink or paint maintain what is described as draw samples on large, paper board sheets which can be registered with similar sized mats thereby allowing one mat to be assigned to each sample substrate.

In another preferred embodiment the transparent characteristic of our mat allows it to be used when isolating a particular sampling area on a material which requires the use of special light sources such as transmitted light from below the sample, to locate the area of interest. The transparent characteristic of the mat allows for the light to pass at full strength into the sample. Therefore this mat may be placed on a light box, material placed on the mat, transmitted light applied from below and directed through the mat and the material, the area of interest identified in the source material and a sample cut on the mat. This becomes important when extracting samples from garments collected at crime scene for body fluids. The fluorescent light source identifies the body fluid of interest through the transparent mat.

The extruded plastic mat has a smooth surface finish such as to not interfere with any selected transparency. The finish may be tinted to any suitable hue or value. A further embodiment resulting from the transparent feature of the mat is the versatility of sampling while the mat rests over documentation. The mat both protects the documents and allows for such documents to be visualized through the mat should they be required for reading prior to, during or following the sampling process or used for tracing a preferred sample shape for placement in a particular scientific instrument. The mat also protects the working surface and can be employed in larger sizes for use on larger working surfaces with the option of disposing of as needed. Still another embodiment related to the transparent feature is that it allows for the optional placement of a printed image on one side of the two exposed cutting surfaces. Such screened images may be text and/or numerical information, boxes or circles to position samples or write information such as date, time, material name as they relate to sampling, onto the cutting support, and scales on the mat to measure the size of sample collected. In one embodiment metric measuring along one edge and decimal measuring along a second edge is optional. Printed information may be added using fluorescent inks for the purpose of sampling materials which can only be viewed under fluorescent light conditions and may include samples of stained biological materials on clothing recovered from a crime scene, components in inks or components in chromatograms which must be cut or removed. The fluorescent printed detail on the mat enables the sample to be positioned in specific target locations on the mat and for subsequent sampled source materials to use other target areas on the same mat by recognizing the fluorescent shape of the target area on the mat.

The cutting mat must be sufficiently hard to resist perforation while not dulling the cutting knife or device. The light weight and high Rockwell hardness make our cutting mat easy to transport and use with a variety of cutting devices while not dulling such devices nor perforating the cutting mat during use. In one example of mat material, Vivak, possesses a heat resistance of 164 degree Fahrenheit, thereby allowing it to be used in some applications where heated materials must be sampled. This material has a Rockwell hardness (Rc) of 115 which is suitable for use with sharp instruments commonly used in scientific examinations to prepare samples. Sheets of between 0.010 and 0.030 can be used while maintaining the flexing capability to be formed into a shallow funnel for transfer of materials from the mat surface to other surfaces or collecting vessels.

Another preferred embodiment is an optional adhesive strip which can be placed on the opposite side of the cutting surface and used to fix the cutting mat to a working surface. This allows the user's hands to be free instead of being used to manually stabilize the cutting mat while portioning a sample from a larger body of material. The adhesive strip allows for the mat to adhere to any surface thereby eliminating the likelihood that the hands or fingers of the user will inadvertently be injured as might occur if the cutting support or cutting device should slip, thereby ensuring high safety and prevention of slippage.

The disposable nature combined with the ease of adopting any size and receiving printed information make our invention a suitable item for marketing in a packaged form by themselves or a kit form with other sample substrates designed to collect samples for scientific analysis such as biological or chemical materials.

The present invention allows the user to portion appropriate size samples from raw materials such as food, plants, agricultural materials, clothing, paint chips, film, paper, human or animal tissue and substrates bearing materials to be sampled such as ink on paper, blood on filter paper, blood on cloth, other biological stains on cloth, etc. Sampling is accomplished by placing the desired material on the surface of the cutting mat and penetrating the material to be sampled with a sharp cutting tool by applying downward pressure, thus the surface of the cutting support is also penetrated but not perforated. This produces a record of the size and location of the cut line produced enabling the analyst to see where a sample was taken on the cutting mat and to avoid re-sampling in the same location, preventing cross contamination. Sheets of 0.010″ to 0.030″ thicknesses are of sufficient hardness to prevent perforation of the cutting device under downward hand pressures used for sampling materials. Such downward pressures may be variable due to the user and material being portioned. The transparent component is multi-functional allowing viewing of text materials while sampling, protecting such materials, protecting the working surface, i.e. counter, use with transmitted light sources and allows view of printed information applied to one side of the mat.

These and other advantages of the invention will be more particularly realized by a reading of the following detailed description of the invention together with the drawings in which like reference numerals refer to like parts throughout.

### BRIEF DESCRIPTION OF THE DRAWINGS

FIG. 1 is a plan view of the cutting mat with printed detail on the underside of the cutting surface and an adhesive strip on the underside of the cutting surface.

FIG. 2 is a cross-sectional view showing the top and bottom surface of the cutting mat and a uniform one component structure without sub-layers as described in the prior art.

FIG. 3 is a perspective view of the cutting mat with a blood filtration card resting on top. A cutting device, in this case a coring tool, cores a sample from the blood filtration card by applying downward pressure and rotating the tool. A sample is pushed into the hollow end of the coring device as the tip of the device penetrates the blood card and then makes contact with the top surface of the mat.

FIG. 4 is a perspective view of the cutting mat with the blood filtration card removed and following sampling in FIG. 3. Note the visual record, location and number of circular core cuts produced by the coring tool and recorded in the top surface of the cutting mat.

FIG. 5 is a perspective view of another design of the same cutting mat without printed text, adhesive strip and provided with rounded corners. In this figure a raw sample of material is positioned on top of the mat. The coring tool cuts a sample from the raw material using the same procedure as described in FIG. 3.

### DESCRIPTION OF PREFERRED EMBODIMENT

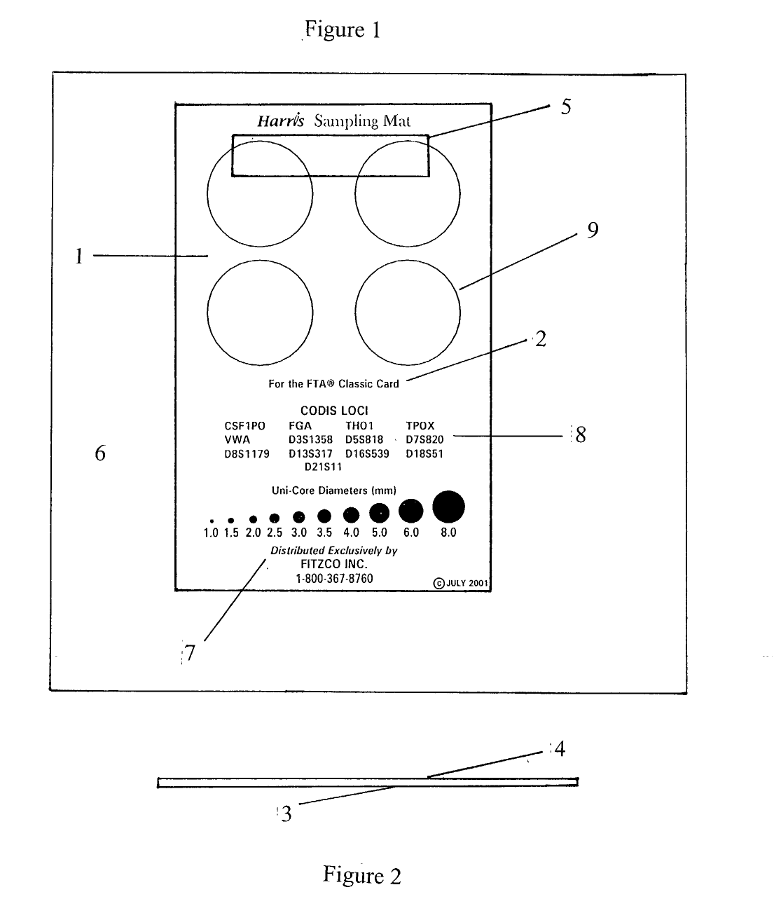

Referring to FIG. 1, a preferred embodiment of a recordable cutting mat for sample collection constructed in accordance with the principles of the invention is shown. A cutting mat 1 of preferred dimension bearing printed detail 2 on the bottom side cutting surface 3 which can be read from the top side cutting surface 4. An adhesive strip 5 positioned on the bottom side 3 of the mat 1 is used to adhere the mat 1 to a surface 6 to prevent slippage, possible injury during sampling and to free both hands to better manipulate the source material to be sampled and cutting device used. The mat 1 is cut from a larger manufactured extruded sheet of plastic. The mat 1 may be cut to any size from a larger source of mat.

In a preferred embodiment the sheet is fully transparent allowing for printed detail 2 on the bottom side 3 of the mat 1 to be viewed through the top side 4 of the mat 1. This printed detail 2 may comprise any text 7, numerical data 8 or graphic image such as circles 9 for positioning the sample or entering information on the mat 1 related to the sample 10 (i.e. blood filter card). The printed detail 2 is functional providing reference information particular to that sampling application for the user to refer to.

Another preferred embodiment of the transparent characteristic of the mat 1 allows it to be used on top of documentation which may be required for reading while preparing a sample from the material on the mat 1 or for tracing the cut of a sample for specific scientific analysis.

In still another embodiment related to the transparent characteristic allows the mat 1 to be used with transmitted light or other special light source, to observe detail embedded in the sample 10 (i.e. garment bearing body fluid) which cannot be seen with the naked eye and may be isolated with the assistance of a special light source such as transmitted or fluorescent light. In another preferred embodiment the printed detail 2 may be printed with fluorescent inks. This may assist the analyst when locating a printed target area on the mat 1 to position a corresponding fluorescent sample such as dried biological fluids on clothing recovered from a crime scene, or minute ink additions added to an original entry and using a similarly colored ink but of different formulation as might occur when altering or raising the amount on a check. The mat's 1 transparent characteristic allows these special light sources to be used without interference from the cutting mat 1.

In still another preferred embodiment the adhesive strip 5 is optional and can be used on either side of the mat 1 to adhere the mat 1 to any surface 6 without affecting that surface. This enables the mat 1 to not only be used on a planar surface but positioned on a vertical surface, or any surface which requires positioning of the mat 1 for sampling.

FIG. 2 shows a cross-section of the cutting mat 1 with a bottom side 3 and a top side 4 cutting surfaces. Both these surfaces are smooth allowing for a material to slide freely on the surface in order to orient for sample cutting. The surface is soft enough to allow penetration and firm enough to prevent perforation of the mat 1 to the second surface on the bottom side 3. The cross-section shows a uniform continuity to the plastic and no layering.

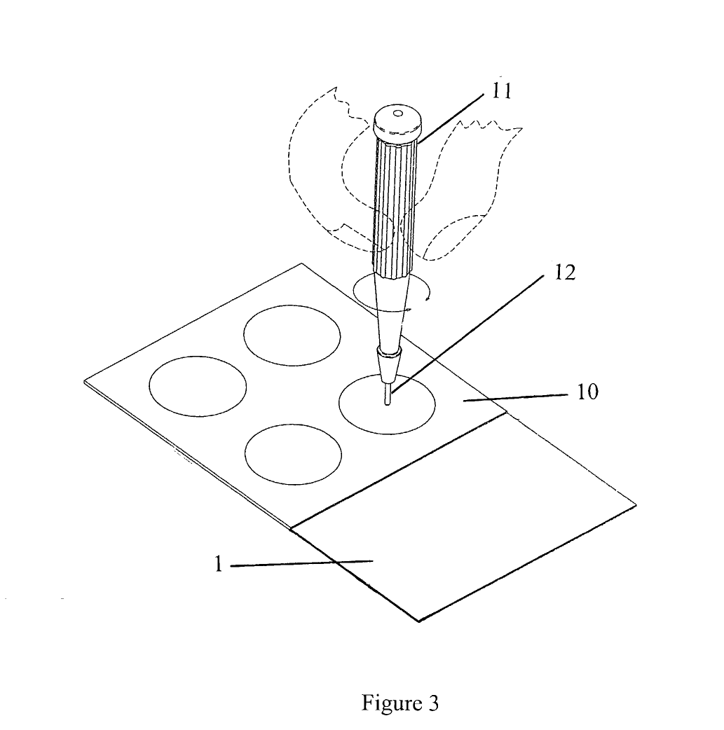

In FIG. 3 a sample substrate (blood filter card) 10 of the same dimensions as the mat 1 can be registered on the mat 1. A coring device 11 is held perpendicular to the sample substrate (blood filter card) 10 and downward pressure together with rotation is applied to the coring device on the blood filter card 10. The coring tool 11 cuts through the blood filter card 10 and makes contact with the mat 1 eventually penetrating the top side 4 of the mat 1 and pushing the cut sample from the blood filter card 10 into the hollow tip 12 of the coring tool 11.

A preferred embodiment is the advantage of pre-cutting these mats 1 to any dimension during the manufacturing stage which allows them to be registered against a variety of substrates surfaces designed to hold sample materials such as dried blood on a blood filter card 10 and documents bearing ink or toner that must be sampled for chemical analysis, etc. This becomes important as it allows for repeated use of the same mat with the same sample substrate, allowing for repeat sampling without cutting over the same location on the mat 1. This record may also act as a security feature as the number of sample removed should agree with the record on the mat. The adhesive strip 5 allows the mat 1 to be fixed to a surface 6 thereby freeing both hands to operate the cutting device 11 and hold the sample 10. The fixing of the mat 1 to the surface 6 prevents slippage of the mat 1 which may affect accuracy of cutting the sample 10 as well as cause injury during the cutting operation.

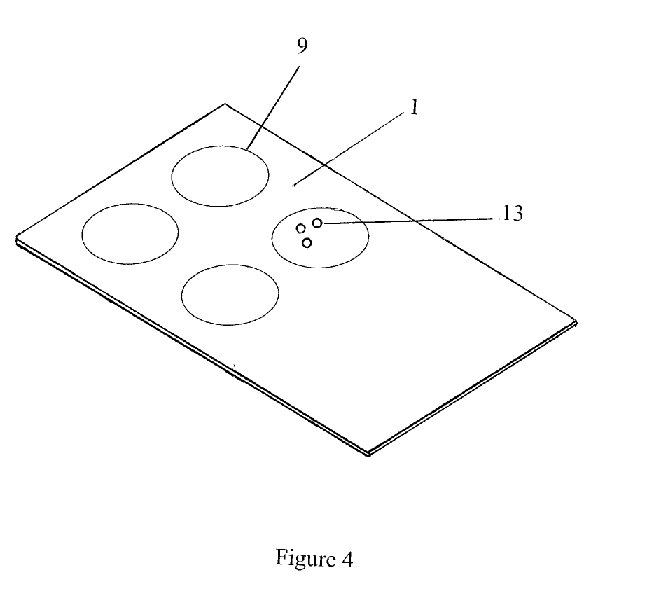

In FIG. 4 a perspective view of the cutting mat 1 without printed detail illustrates the visible record of the location, size, and number of cuts 13 made in the surface of the mat 1. In an embodiment vital to the use of this mat for cutting materials and potential re-use in scientific applications, this cutting mat 1 records cut lines 13 in the surface of one side of the mat 1. This is important because this record provides valuable information and also enables re-use of the mat 1. The size, number and location of the cut lines 13 ensures that repeat sampling using this mat 1 will not take place over prior cut lines 13 which might contaminate the new sample. The record of cut lines 13 can be used to confirm how many samples have been prepared from a particular material.

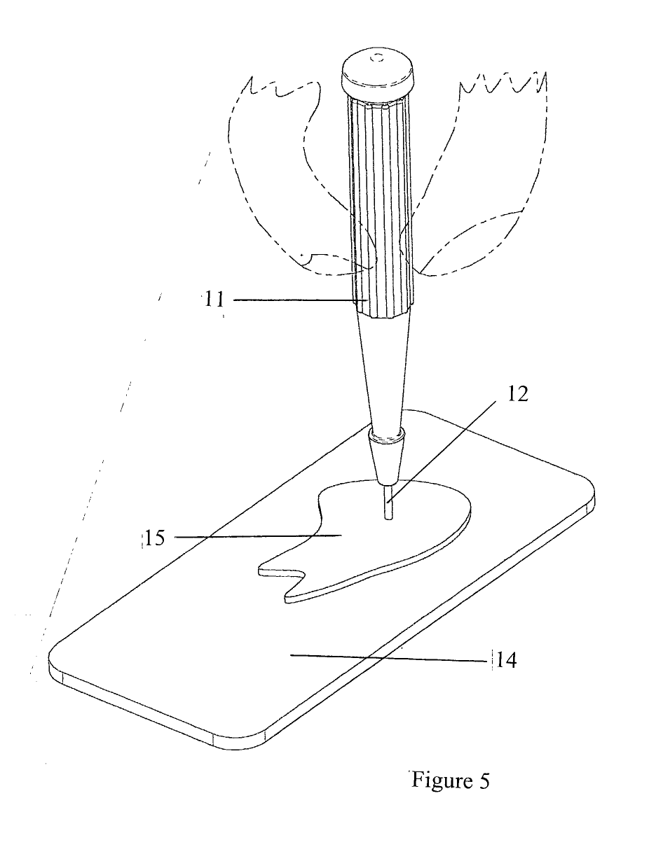

FIG. 5 shows a different dimension and shape of mat 14 with rounded corners with a raw sample 15 positioned on the top side 4. A coring tool 11 is positioned perpendicular to the mat 14 and downward pressure together with rotation is applied to the tool and therefore the raw sample 15. The coring tool 11 cuts through the raw sample 15 and makes contact with the top surface 4 of the mat 14 eventually penetrating the top surface 4 of the mat 14. When this occurs the top surface 4 of the mat 14 pushes the cut sample from the raw material 15 into the tip 12 of the tool 11. Following sampling of the raw material 15, the mat 14 may be folded into a shallow funnel to transport the remaining material or the sample cut from the material to another location or remove from the mat for re-use of the mat.

In another preferred embodiment the size and light weight of the mat 14 allows the mat 14 to be pre-packaged as a disposable packet of sampling mats which can be used at testing locations where the mat 14 could be disposed of following each sample cutting. The mat 14 is hardy and versatile and is not restricted to use in a laboratory environment but may see multiple application outside the conventional laboratory at such locations as crime scenes, environmental testing areas, etc.

Although for the purposes of the above illustrations we have chosen to use a coring tool as an example of a cutting device for use with our mat, it is just that, an example and is not meant to suggest preferred use as any other cutting device may be used on this mat to sample material.

It has been found that materials under such brand names as Vivak, Lexan, or other co-polymers possess the requisite clarity, toughness, chemical solvent and stress cracking resistance to be suitable and possess the preferred embodiments described above as cutting mats for sampling material to be scientifically analyzed.

Obviously, other embodiments and modifications of the present invention will occur readily to those of ordinary skill in the art in view of these teachings. Therefore, this invention is to be limited only by the following claims, which include all such other embodiments and modifications when viewed in conjunction with the above specification and accompanying drawings.

I claim:

1. A disposable cutting mat with a recordable surface to support materials to be cut into samples for scientific analysis comprising:
a flat smooth surface;
a thickness range of 0.010 to 0.030 inches;
any dimension or shape prepared from an extruded 4×8 sheet of plastic;
a transparent composition;
the ability to record cut lines produced by different cutting tools;
an optionally placed adhesive strip positioned on one side of the cutting surface;
the option of using one or both sides of the cutting surface;
optionally printed information on one side of the cutting surface either as text or line art a Rockwell hardness of approximately 75 to 125

2. The apparatus of claim 1 wherein said plastic material is comprised of extruded transparent copolymer such as Lexan or Vivak.

3. The apparatus of claim 1 wherein said plastic mat is flexible with a thickness range of 0.010 to 0.030 inches.

4. The apparatus of claim 2 wherein the composition of the material copolymer will accept a printed image.

5. The apparatus of claim 1 wherein the mat is transparent to allow the transmission of various wavelengths of light through the mat to the material being sampled for the purposes of locating appropriate sampling areas on the material.

6. The apparatus of claim 5 wherein the transparent feature of the mat allows it to be placed over reference text which can be viewed through the mat while preparing a sample.

7. The apparatus of claim 1 wherein the cutting mat may be cut to any size during the manufacturing process such that it will be registered to fit any preferred dimension of pre-existing substrate used for the purposes of collecting sample material, i.e fitted to a blood filter card, piece of paper, etc.

8. The cutting mat can be cut to any dimension so as to provide a wide range of uses on a wide range of surfaces according to claim 8.

9. The apparatus of claim 1 wherein the surface of the mat is soft enough to allow penetration of the cutting device but not perforation-and dulling of knife.

10. The apparatus of claim 1 wherein the mat receives and records all cut lines made from a cutting device used to sample a material or substrates bearing a material such as dried blood on a blood filter card. This visible record of cut lines in the cutting mat surface provides information on the number, size and location of sample cuts produced on the respective material. It also provides a security feature for recording the number of cuts from a specific sample should that sample be inadvertently removed and sampled elsewhere not using the associated registered cutting mat.

11. The apparatus of claim 10 wherein the visible record of cuts in the mat surface allows the user to avoid subsequent cutting of other samples on the same mat area if said mat is re-used, thereby avoiding contamination.

12. The apparatus of claim 1 wherein the 4×8 sheet is of such low expense that sample cutting mats can be produced in volumes such that they are deemed disposable and can be sold in packages as such or as part of another associated product such as a blood filter card sample kit.

13. The apparatus of claim 1 wherein the adhesive strip is such that it can be removed from one side of the mat and affixed to the other side when using the other cutting surface. The strip is designed to hold the mat firm to a surface but is not of such strength to affect or damage such surface.

14. The apparatus of claim 14 wherein the adherence of the mat to a surface prevents movement of the cutting mat but also allows the user to make better use of their hands for manipulating and cutting a sample from the material. This reduces slippage of the mat and makes for a more safe sampling method.

15. The apparatus of claim 1 wherein the extruded plastic is not reactive to ethanol and therefore can be sterilized between sample extractions.

16. The apparatus of claim 1 wherein the extruded plastic may be of any color or hue for specific applications and as a filter for applications with crime evidence.
